(19) United States
(12) Patent Application Publication
(10) Pub. No.: US 2008/0085941 A1
(43) Pub. Date: Apr. 10, 2008

(54) Particle Dispersion

(75) Inventor: Frank Sandmeyer, Burgkirchen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/866,450

(22) Filed: Oct. 3, 2007

(30) Foreign Application Priority Data
Oct. 4, 2006 (DE) 10 2006 046 957.7

(51) Int. Cl. B01F 3/12

(52) U.S. Cl. 516/77

(57) ABSTRACT

A method of dispersing solid which is soluble to not more than 1 part by weight in 100 parts by weight of water at 20° C. and 1020 hPa, which method comprises incorporating at least one self-emulsifying organopolysiloxane (A) and then incorporating solid (B) into an aqueous composition.

### BACKGROUND OF THE INVENTION

1. Field of the Invention

The invention relates to a method of dispersing solid particles in water.

2. Background Art

Hydrophobic particles cannot readily be dispersed homogeneously in water. Dispersion takes place using, in particular, emulsifiers, which later often interfere in end use applications.

EP 0 609 524 B1 discloses self-dispersing aqueous compositions of hydrophobic solids and organopolysiloxanes which are salts of organopolysiloxanes having Si—C bonded radicals containing basic nitrogen with organic or inorganic acids. Such compositions are obtained by admixing a hydrophobic solid to the organopolysiloxane compositions. On dilution with water the mixtures obtained produce homogeneous dispersions in which the hydrophobic solids are distributed in a finely disperse form.

EP 0 609 524 B1 also discloses use of the aqueous dispersions obtainable thereby, for surface treatment after dilution with water. However, there are commercially available products which exhibit end-use properties which are not always obtainable or improved by the compositions of EP 0609 524 B1. Instead, the compositions of the latter have other specific advantages. Moreover, in the compositions of EP 0 609 524 B1, the predominant fraction of the composition is always the organopolysiloxane mixture, not the particle species. Thus, for example, it is not possible to incorporate more than 7% of hydrophobic fumed silica of the type WACKER HDK® H18 into the organopolysiloxane composition (A) from EP 0 609 524 B1, according to Example 1, since the increase in viscosity of the composition is so sharp that the composition is no longer processable under technically relevant conditions.

### SUMMARY OF THE INVENTION

The object of the present invention was to improve on the prior art, and more particularly to develop a highly universal method that allows hydrophobic solids to be incorporated into commercially customary aqueous products without the need for changes to the formulation of the products, and in particular without the use of emulsifiers. A further object was to provide a broadly applicable method such that selection of the respective hydrophobic solids remains largely a matter for the formulator. These and other objects are achieved by a method for preparing dispersions of hydrophobic solids where an aqueous dispersion or emulsion of a self-emulsifying organopolysiloxane is first produced, and hydrophobic solid is then incorporated therein.

### DETAILED DESCRIPTION OF THE PREFERRED EMBODIMENT(S)

The invention thus provides a method for dispersing a solid which has a water solubility of less than or equal to 1 weight percent at 20° C. and 1020 hPa, the method comprising incorporating at least one self-emulsifying organopolysiloxane (A) into an aqueous preparation, and then incorporating solid (B).

“Self-dispersibility” means, in the context of this invention, that the compositions of the invention produce stable aqueous dispersions or emulsions with water spontaneously and without the use of the mechanical energy typically employed for producing dispersions, by simple pouring into water and stirring.

The weight percentages of “basic nitrogen” referred to herein relate to nitrogen calculated as the element.

Besides self-emulsifying organopolysiloxane (A) the compositions preferably contain a compound (C), organosilicon compounds containing basic nitrogen in amounts of 0 to 0.5 percent by weight, based on the weight of this organosilicon compound.

The self-emulsifying organopolysiloxane is preferably
(A) a salt of organic or inorganic acids and organopolysiloxanes bearing SiC-bonded radicals containing basic nitrogen in amounts of at least 0.5 percent by weight of basic nitrogen, based on the weight of this organopolysiloxane.

Aqueous compositions in accordance with the method of the invention are all compositions into which the polyorganosiloxane compositions can be stably incorporated. The aqueous compositions preferably have the properties described below, and are useful in applications such as the production of coating materials and impregnated systems, and coatings and coverings obtainable therefrom on substrates, and also for the purpose of defoaming, promoting flow, hydrophobicizing, hydrophilicizing, filler and pigment dispersing, filler and pigment wetting, substrate wetting, promotion of surface smoothness, and reduction of sticking resistance and sliding resistance.

The organopolysiloxanes from which constituent (A) of the composition of the invention is obtained by reaction with organic or inorganic acid are preferably those of the formula

$${R}_{a} {{R}_{b}^{1} ( {OR}^{2} )}_{c} {SiO}_{\frac{4 - a - b - c}{2}} \qquad ( I )$$

in which
R can be identical or different and denotes hydrogen or monovalent, SiC-bonded organic radicals free from basic nitrogen,
R¹ can be identical or different and denotes monovalent, SiC-bonded radicals containing basic nitrogen,
R² can be identical or different and denotes hydrogen atom or monovalent organic radicals,
a is 0, 1, 2 or 3,
b is 0, 1, 2 or 3, and
c is 0, 1, 2 or 3,
   with the proviso that the sum of a, b, and c is less than or equal to 3 and radical R¹ is present in amounts of more than 0.5 percent by weight of basic nitrogen per organopolysiloxane molecule.

Radical R preferably comprises unsubstituted or substituted hydrocarbon radicals having 1 to 20 carbon atoms, particular preference being given to hydrocarbon radicals having 1 to 8 carbon atoms, more particularly the methyl and the isooctyl radicals.

Preferably there is also a hydrocarbon radical, more particularly a methyl radical, attached to each silicon atom to which a hydrogen atom is attached.

Examples of radicals R are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, octadecyl radicals such as the n-octadecyl radical; alkenyl radicals such as the vinyl, allyl, n-5-hexenyl, 4-vinylcyclohexyl, and 3-norbornenyl radicals; cycloalkyl radicals such as the cyclopentyl, cyclohexyl, 4-ethylcyclohexyl, cycloheptyl, norbornyl, and methylcyclohexyl radicals; aryl radicals such as the phenyl, biphenyl, naphthyl, anthryl, and phenanthryl radicals; alkaryl radicals such as the o-, m-, and p-tolyl radicals, xylyl radicals, and ethylphenyl radicals; and aralkyl radicals such as the benzyl radical, and the α- and the β-phenylethyl radicals.

Examples of substituted hydrocarbon radicals R are halogenated hydrocarbon radicals such as the chloromethyl, 3-chloropropyl, 3-bromopropyl, 3,3,3-trifluoropropyl, and 3,3,4,4,5,5,5-heptafluoropentyl radicals, and also the chlorophenyl, dichlorophenyl, and trifluorotolyl radicals; mercaptoalkyl radicals such as the 2-mercaptoethyl and 3-mercaptopropyl radicals; cyanoalkyl radicals such as the 2-cyanoethyl and 3-cyanopropyl radicals; acyloxyalkyl radicals such as the 3-acryloyloxypropyl and 3-methacryloyloxypropyl radicals; hydroxyalkyl radicals, such as the hydroxypropyl radical, and radicals of the formula

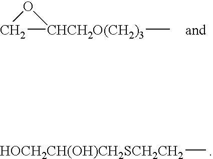

Radical R¹ preferably comprises radicals of the formula

R₂³NR⁴— (II),

in which R³ can be identical or different and denotes hydrogen or monovalent hydrocarbon radical, unsubstituted or substituted by amino groups, and R⁴ denotes a divalent hydrocarbon radical.

Examples of radical R³ are the examples of hydrocarbon radicals given for radical R, and also hydrocarbon radicals substituted by amino groups, such as aminoalkyl radicals, particular preference being given to the aminoethyl radical. Preferably there is at least one hydrogen atom attached to each nitrogen atom in the radicals of the formula (II). R⁴ preferably comprises divalent hydrocarbon radicals having 1 to 10 carbon atoms, with particular preference 1 to 4 carbon atoms, and in particular, the n-propylene radical. Examples of radical R⁴ are the methylene, ethylene, propylene, butylene, cyclohexylene, octadecylene, phenylene, and butenylene radicals.

Examples of radicals R¹ are H₂N(CH₂)₃—, H₂N(CH₂)₂NH(CH₂)₂—, H₂N(CH₂)₂NH(CH₂)₃—, H₂N(CH₂)₂, H₃CNH(CH₂)₃—, C₂H₅NH(CH₂)₃—, H₃CNH(CH₂)₂—, C₂H₅NH(CH₂)₂—, H₂N(CH₂)₄—, H₂N(CH₂)₅—, H(NHCH₂CH₂)₃—, C₄H₉NH(CH₂)₂NH(CH₂)₂—, cyclo-C₆H₁₁NH(CH₂)₃—, cyclo-C₆H₁₁NH(CH₂)₂—, (CH₃)₂N(CH₂)₃—, (CH₃)₂N(CH₂)₂—, (C₂H₅)₂N(CH₂)₃—, and (C₂H₅)₂N(CH₂)₂—. R¹ preferably comprises H₂N(CH₂)₃— and H₂N(CH₂)₂NH(CH₂)₃—, particular preference being given to H₂N(CH₂)₂NH(CH₂)₃—. Furthermore, radical R¹ may also comprise cyclic amine radicals, such as piperidyl radicals.

R² preferably comprises a hydrogen atom or an alkyl radical having 1 to 4 carbon atoms, particular preference being given to the methyl, ethyl, and propyl radicals. The foregoing examples of alkyl radicals R also apply fully to the radical R².

The average value for a is 0 to 2, preferably 0 to 1.8; the average value for b is 0.1 to 0.6, preferably 0.15 to 0.30; and the average value for c is 0 to 0.8, preferably 0.01 to 0.6.

Examples of organopolysiloxanes composed of units of the formula (I) are the reaction product of tetraethyl silicate with N-(2-aminoethyl)-3-aminopropyltrimethoxysilane, having a viscosity at 25° C. of 6 to 7 mm²/s and an amine number of 2.15 (siloxane i); the reaction product of α, ω-dihydroxydimethylpolysiloxane and N-(2-aminoethyl)-3-aminopropyltrimethoxysilane, having a viscosity of 20 to 50 mm²/s (25° C.) and an amine number of 2.7 to 3.2 (siloxane ii); and the reaction product of CH₃Si(OC₂H₅)_{0.8}O_{1.1} and N-(2-aminoethyl)-3-aminopropyltrimethoxysilane, having a viscosity of 60 mm²/s (25° C.) and an amine number of 2.15 (siloxane iii), preference being given to (siloxane ii) and (siloxane iii), and particular preference to (siloxane ii). The amine number corresponds to the number of ml of 1N HCl needed to neutralize 1 g of substance.

The organopolysiloxanes composed of units of the formula (I) preferably have a viscosity of 6 to 60 mm²/s, based on 25° C. Organopolysiloxanes composed of units of the formula (I) can be prepared in a known way, as for example by equilibration and/or condensation of amino-functional silanes with organopolysiloxanes which are free from basic nitrogen.

The organic or inorganic acids used to prepare constituent (A) of the composition of the invention may be any acids useful for preparing salts of organic or inorganic acid and organopolysiloxane having SiC-bonded radicals containing basic nitrogen. Examples of such acids are preferably HCl, H₂SO₄, acetic acid, propionic acid, and diethyl hydrogen phosphate, preference being given to acetic acid and propionic acid, and particular preference being given to acetic acid.

Compounds which can be used as component (A) in the composition of the invention are already known. In this regard reference may be made, for example, to U.S. Pat. No. 4,661,551. The organopolysiloxane salt used as component (A) may comprise a single kind of this salt or else a mixture of at least two kinds of such salts.

The hydrophobic solids (B) used in accordance with the invention, in other words solids which are soluble to not more than one part by weight in 100 parts by weight of water at 20° C. and 1020 hPa, are preferably fillers, pigments, biocides, and solids that absorb ultraviolet light, preferably with the exception of organosilicon compounds that are solid at 20° C. and 1020 hPa and which under those conditions dissolve to the extent of more than 50 parts by weight in 100 parts by weight of (A), alone, or in admixture with (C).

Examples of hydrophobic fillers are preferably nonreinforcing fillers, in other words fillers having a BET surface area of up to 50 m²/g, such as quartz, diatomaceous earth, calcium silicate, zirconium silicate, zeolites, montmorillonites such as bentonites, metal oxide powders, such as aluminum, titanium, iron or zinc oxides and/or their mixed oxides, barium sulfate, calcium carbonate, silicon nitride, silicon carbide, boron nitride, glass powders and polymer powders; preferably reinforcing fillers, in other words fillers having a BET surface area of more than 50 m²/g, such as fumed silica, precipitated silica, carbon black such as furnace black and acetylene black, mixed silicon aluminum oxides of high BET surface area, and fibrous fillers such as asbestos and also polymeric fibers. The stated fillers may have been hydrophobicized, for example through treatment with organosilanes and/or organosiloxanes, or through etherification of hydroxyl groups to alkoxy groups.

Examples of pigments are earthy pigments, preferably such as chalk, ocher, umber, and green earth; mineral pigments such as titanium dioxide, chrome yellow, red lead oxide, zinc yellow, zinc green, cadmium red, and cobalt blue; organic pigments such as sepia, Cassel brown, indigo, azo pigments, anthraquinonoid pigments, indigoid pigments, dioxazine pigments, quinacridone pigments, phthalocyanine pigments, isoindolinone pigments, and alkali blue pigments; with many of the inorganic pigments also functioning as fillers, and vice versa.

Examples of hydrophobic biocides are fungicides, insecticides, herbicides, and algicides such as benzimidazole derivatives. Examples of solids which absorb ultraviolet light are benzotriazole, tolyltriazole, and transparent iron oxide pigments.

As solid (B) the composition of the invention preferably comprises hydrophobic, highly disperse fumed silica having a surface area of approximately 140 m²/g, which can be prepared by flame hydrolysis of volatile silicon compounds and subsequent hydrophobicization with organosilanes.

The compositions of the invention preferably contain hydrophobic solid (B) in amounts of from 0.1 to 15 parts by weight, more preferably of 0.5 to 2 parts by weight, per part by weight of constituent (A). It is possible to use one kind of solid (B) or else a mixture of at least two different kinds of such solids.

The organosilicon compound (C) used if desired preferably comprises composed of those units of the formula

$${{R}_{d}^{5} ( {OR}^{6} )}_{e} {SiO}_{\frac{4 - d - e}{2}}$$

### (III),

in which
R⁵ can be identical or different and denotes hydrogen or a monovalent SiC-bonded organic radical,
R⁶ can be identical or different and denotes hydrogen atom or monovalent organic radical,
d is 0, 1, 2, 3 or 4 and
e is 0, 1, 2, 3 or 4,
   with the proviso that the sum of d and e is less than or equal to 4 and the basic nitrogen content is 0 to 0.5 percent by weight, based on the weight of the respective organosilicon compound.

Examples of radical R⁵ are the examples given for radical R, and also hydrocarbon radicals substituted by amino groups, preference being given to hydrocarbon radicals having 1 to 8 carbon atoms, with particular preference given to the methyl and isooctyl radicals.

Examples of radical R⁶ are the radicals given for R², preference being given to the methyl, ethyl, and propyl radicals, with particular preference given to the methyl and ethyl radical.

The organosilicon compound composed of units of the formula (III) may comprise silanes, i.e., the sum of d and e is 4, and may also comprise organopolysiloxanes, i.e., the sum of d and e is less than or equal to 3. Examples of silanes of the formula (III) are isooctyltrimethoxysilane and isooctyltriethoxysilane. Examples of organopolysiloxanes composed of units of the formula (III) are methylethoxypolysiloxanes, dimethylpolysiloxanes, and isooctylmethoxypolysiloxanes. The organopolysiloxanes composed of units of the formula (III) preferably have a viscosity of 5 to 2000 mm²/s, more preferably 10 to 500 mm²/s, in each case measured at 25° C.

The organosilicon compound (C), when employed, preferably comprises silanes and low molecular weight siloxanes, more preferably silanes. Processes for preparing the organosilicon compounds composed of units of the formula (III) are widely and numerously known.

When organosilicon compounds (C) are used for preparing the composition of the invention, it is preferably employed in amounts of 0.5 to 15 parts by weight, more preferably 1 to 3 parts by weight, per part by weight of component (A). The compositions of the invention preferably contain a component (C). The organosilicon compound (C), employed if desired, may comprise one kind or else a mixture of at least two kinds of such an organosilicon compound.

The compositions of the invention may comprise further components, such as preservatives, dispersants, and organic solvents, for example. Preferably, however, the compositions of the invention are free from organic solvent or contain organic solvent in amounts of not more than 10 percent by weight, based on the total weight of component (A) and optional component (C).

At the same time, the emulsifiers, from which the compositions are preferably essentially free in accordance with the method of the invention, typically have a solubility in water at 20° C. and the pressure of the surrounding atmosphere, i.e., 900 to 1100 hPa, homogeneously or in micelle form, of greater than 1% by weight. The compositions according to the method of the invention can comprise such surface-active substances up to a maximum concentration of less than 0.1 times, preferably less than 0.01 times, more preferably less than 0.001 times, and in particular less than 0.0001 times the critical micelle concentration of these surface-active substances in the water phase; corresponding to a concentration of these surface-active substances, based on the total weight of the emulsion of the invention, of less than 10%, preferably less than 2%, more preferably less than 1%, and in particular, 0% by weight.

The method can in principle be applied to all compositions into which the polyorganosiloxane compositions can be stably incorporated. Owing to the siloxane properties and the properties anticipated for hydrophobic solids, the principal fields of application are in sectors within which a powerful hydrophobicization has a part to play. These include, primarily, the hydrophobicization of mineral construction materials, including facings, roads, and bridges, such as roofing shingles, bricks, reinforced and unreinforced concrete, plaster, slag blocks and limestone sand blocks, and wood; and also the hydrophobicizing treatment of textiles, leather, metals (for corrosion control, for example) and paper and cardboard. The method of the invention is also suitably applied in particular to the production of water-dilutable compositions, such as paints, plasters, polishes, etc.

In addition to uses for hydrophobicization, the method of the invention can also be applied to compositions which are used for corrosion control on metals and for manipulation of further properties, such as, for example:
controlling the electrical conductivity and electrical resistance
controlling the flow properties of a composition
controlling the gloss of a wet or cured film or of an object
increasing the weathering resistance
increasing the chemical resistance
increasing the shade stability
reducing the chalking tendency
reducing or increasing the static friction and sliding friction
stabilizing or destabilizing foam
promoting adhesion,
controlling filler and pigment wetting and dispersing behavior,
controlling the rheological properties
controlling the mechanical properties, such as flexibility, scratch resistance, elasticity, extensibility, bendability, tensile behavior, rebound behavior, hardness, density, tear propagation resistance, compression set, behavior at different temperatures, expansion coefficient, abrasion resistance, and other properties, such as thermal conductivity, combustibility, gas permeability, resistance to water vapor, hot air, chemicals, weathering, and radiation, and sterilizability
controlling the electrical properties, such as dielectric loss factor, breakdown resistance, dielectric constants, creep current resistance, light arc resistance, surface resistance, specific breakdown resistance,
flexibility, scratch resistance, elasticity, extensibility, bendability, tensile behavior, rebound behavior, hardness, density, tear propagation resistance, compression set, behavior at different temperatures.

Examples of application for which the method of the invention can be used in order to manipulate the properties identified above are the production of coating materials and impregnated systems, and coatings and coverings obtained therefrom on substrates preferably substrates such as metal, glass, wood, mineral substrates, synthetic fibers and natural fibers for producing textiles, carpets, floor coverings, or other goods which can be produced from fibers, or on leather, plastics such as films and sheets, moldings, and also for the purpose of defoaming, promoting flow, hydrophobicizing, hydrophilicizing, filler and pigment dispersing, filler and pigment wetting, substrate wetting, promotion of surface smoothness, and reduction of sticking resistance and sliding resistance.

The method of the invention can be applied to elastomer compounds. In this context the objectives of application may be the strengthening or improving of other use properties, such as the control of transparency, heat resistance, yellowing tendency and/or weathering resistance.

In accordance with the method of the invention it is also possible to make the ratio of particle to organopolysiloxane composition such that substantially more hydrophobic particles relative to the organopolysiloxane composition are incorporated into the target compositions. This is shown by the examples of the present description.

### EXAMPLES

### Example 1

A Composition of organopolysiloxanes containing basic nitrogen (siloxane A): In a 1 l three-neck flask equipped with stirrer, dropping funnel, and reflux condenser a mixture of 0.2 g of KOH in 4 g of methanol and 500 g of an α,ω-dihydroxydimethylpolysiloxane having an average molecular weight of approximately 4000 g/mol is admixed with stirring with 150 g of N-(2-aminoethyl)-3-aminopropyltrimethoxysilane and the resulting mixture is heated under reflux at boiling for 6 hours. It is then cooled to 30° C. and 2.5 ml of 10% strength hydrochloric acid are added. The methanol is distilled off by heating at up to 140° C., and the resulting organopolysiloxane is freed from KCl by filtration. The organopolysiloxane obtained has a viscosity of 50 mm²/s and contains 2.9% basic nitrogen, based on its weight.

20 g of the aminosiloxane prepared above under A, 3 g of acetic acid, 47 g of isooctyltrimethoxysilane, and 30 g of hydrophobic, highly disperse fumed silica (obtainable commercially under the designation HDK H 2000 from Wacker-Chemie GmbH) are mixed with one another to produce a homogeneous mixture exhibiting a slight Tyndall effect. When introduced into water, the resulting mixture is spontaneously self-dispersing, the hydrophobic silica being distributed in water in a very finely disperse form. The 10% aqueous dilution obtained in this way is stable for a period of more than 6 months at room temperature and under the transmission electron microscope exhibits a hydrophobic silica particle size of approximately 10 to 20 nm.

### Example 2

B Composition of organopolysiloxanes containing basic nitrogen (siloxane B): In a 1 l three-neck flask equipped with stirrer, dropping funnel, and reflux condenser a mixture of 0.2 g of KOH in 4 g of methanol and 500 g of an organopolysiloxane of empirical formula CH₃Si(OC₂H₅)_{0.8}O_{1.1} having an average molecular weight of approximately 600 g/mol and of a viscosity of approximately 20 mm²/s is admixed with stirring with 150 g of N-(2-aminoethyl)-3-aminopropyltrimethoxysilane and the resulting mixture is heated under reflux at boiling for 6 hours. It is then cooled to 30° C. and 2.5 ml of 10% strength hydrochloric acid are added. The methanol is distilled off by heating at up to 140° C. and the resulting organopolysiloxane is freed from KCl by filtration. The organopolysiloxane obtained has a viscosity of 60 mm²/s and a molar weight of approximately 1800 g/mol and contains 2.9% basic nitrogen, based on its weight.

25 g of the aminosiloxane prepared above under B, 5 g of propionic acid, 65 g of propyltrimethoxysilane, and 5 g of a UV light stabilizer containing benzotriazole as UV absorber (obtainable commercially under the designation “Tinuvin 320” from Ciba-Geigy) are mixed with one another to produce a homogeneous mixture exhibiting a slight Tyndall effect. When introduced into water, the resulting mixture is spontaneously self-dispersing, the hydrophobic photoprotectant being distributed in water in a very finely disperse form. The 10% aqueous dilution obtained in this way is stable for a period of more than 6 months at room temperature and under the transmission electron microscope exhibits a hydrophobic photoprotectant particle size of approximately 10 to 50 nm.

### Example 3

Incorporation of hydrophobic fumed silica into an aqueous composition of a polyacrylate using the organopolysiloxane mixture (A): 135 g of a 20 percent by weight aqueous dispersion of a carboxy-functional and ammonia-neutralized polyacrylate, adjusted so that it is self-emulsifying, the dispersion stability having been increased by the addition of 0.2 percent by weight, based on solids content, of sodium dodecylsulfonate, and the particle size of the polyacrylate having been adjusted to below 100 nm, were admixed with 15 g of the organopolysiloxane mixture (A), which was distributed homogeneously by stirring with a paddle stirrer. Thereafter 9.9 g of fumed silica (WACKER HDK® H 18) were added with stirring in the dissolver (2000 rpm). Following the complete addition of the HDK, stirring was continued for 5 minutes. This gave a paste which, through addition of water, was dilutable to form a readily mobile aqueous composition in which the fumed silica is distributed homogeneously and in finely disperse form.

### Comparative Example 1

Incorporation of hydrophobic fumed silica into an aqueous composition of a polyacrylate using the organopolysiloxane mixture (A): 100 g of a 20 percent by weight aqueous dispersion of a carboxy-functional and ammonia-neutralized polyacrylate, adjusted so that it is self-emulsifying, the dispersion stability having been increased by the addition of 0.2 percent by weight, based on solids content, of sodium dodecylsulfonate, and the particle size of the polyacrylate having been adjusted to below 100 nm, were admixed with 6.6 g of fumed silica (WACKER HDK® H 18) with stirring in the dissolver (2000 rpm). Following the complete addition of the HDK, attempts were made to carry out dispersion for a further 15 minutes, but without success; it was not possible to incorporate the fumed silica into the aqueous phase.

### Example 4

Incorporation of hydrophobic fumed silica into an aqueous composition of a polyacrylate using the organopolysiloxane mixture (A): 135 g of a 20 percent by weight aqueous dispersion of a carboxy-functional and ammonia-neutralized polyacrylate, adjusted so that it is self-emulsifying, the dispersion stability having been increased by the addition of 0.2 percent by weight, based on solids content, of sodium dodecylsulfonate, and the particle size of the polyacrylate having been adjusted to below 100 nm, were admixed with 2 g of the organopolysiloxane mixture (A), which was distributed homogeneously by stirring with a paddle stirrer. Thereafter 12.0 g of fumed silica (WACKER HDK® H 18) were added with stirring in the dissolver (2000 rpm). Following the complete addition of the HDK, stirring was continued for 5 minutes. This gave a paste which, through addition of water, was dilutable to form a readily mobile aqueous composition in which the fumed silica is distributed homogeneously and in finely disperse form.

### Comparative Example 2

Dispersing a maximum amount of fumed silica WACKER HDK® H 18 into organopolysiloxane mixture (A):

20 g of polyorganosiloxane mixture (A) are admixed with 1.2 g of WACKER HDK® H 18 fumed silica and homogeneously dispersed in a dissolver (2000 rpm). This produces a paste which does not admit any further incorporation of fumed silica. Even an only approximately similar-sized amount of WACKER HDK® H 18, calculated on the basis of the amount of organopolysiloxane (A) employed as in Example 4, cannot be introduced into this composition in this way.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of dispersing a solid which is soluble to an extent of not more than 1 part by weight in 100 parts by weight of water at 20° C. and 1020 hPa, comprising incorporating at least one self-emulsifying organopolysiloxane (A) into water and then incorporating said solid (B) into an aqueous composition, to form an aqueous dispersion of the solid.

2. The method of claim 1, wherein (C) at least one organosilicon compound containing basic nitrogen in an amount of from 0 to 0.5 percent by weight based on the weight of this organosilicon compound, is additionally incorporated.

3. The method of claim 1, wherein the self-emulsifying organopolysiloxane (A) comprises a salt of at least one organic or inorganic acid and an organopolysiloxane that has SiC-bonded radicals containing basic nitrogen in an amount of more than 0.5 percent by weight of basic nitrogen based on the weight of the organopolysiloxane.

4. The method of claim 1, wherein the organopolysiloxanes from which constituent (A) is obtained by reaction with organic or inorganic acid(s) are those of the formula
$${R}_{a} {{R}_{b}^{1} ( {OR}^{2} )}_{c} {SiO}_{\frac{4 - a - b - c}{2}} \qquad ( I )$$
in which
R are identical or different and denote hydrogen or monovalent, SiC-bonded organic radicals free from basic nitrogen,
R¹ are identical or different and denote monovalent, SiC bonded radicals containing basic nitrogen,
R² are identical or different and denote hydrogen or monovalent organic radicals,
a is 0, 1, 2 or 3,
b is 0, 1, 2 or 3, and
c is 0, 1, 2 or 3,
with the proviso that the sum of a, b, and c is less than or equal to 3 and radical R¹ is present in an amount to provide more than 0.5 percent by weight of basic nitrogen per organopolysiloxane molecule.

5. The method of claim 1, wherein the organosilicon compound (C) comprises those composed of units of the formula
$${{R}_{d}^{5} ( {OR}^{6} )}_{e} {SiO}_{\frac{4 - d - e}{2}} \qquad ( III )$$
in which
R⁵ are identical or different and denote hydrogen or a monovalent SiC-bonded organic radical,
R⁶ are identical or different and denote hydrogen or monovalent organic radicals,
d is 0, 1, 2, 3 or 4 and
e is 0, 1, 2, 3 or 4,
with the proviso that the sum of d and e is less than or equal to 4 and the basic nitrogen content is 0 to 0.5 percent by weight, based on the weight of the respective organosilicon compound.

6. The method of claim 1, wherein the solid (B) comprises at least one solid selected from the group consisting of fillers, pigments, biocides, and solids which absorb ultraviolet light.

7. The method of claim 1, further comprising coating or impregnating a substrate with the aqueous dispersion.
